(19) United States
(12) Patent Application Publication
(10) Pub. No.: US 2020/0234709 A1
(43) Pub. Date: Jul. 23, 2020

(54) METHOD, CONTROL DEVICE, AND PROGRAM

(71) Applicant: Panasonic Intellectual Property Corporation of America, Torrance, CA (US)

(72) Inventor: Yuji KUNITAKE, Osaka (JP)

(21) Appl. No.: 16/842,099

(22) Filed: Apr. 7, 2020

Related U.S. Application Data
(63) Continuation of application No. PCT/JP2019/030045, filed on Jul. 31, 2019.

(30) Foreign Application Priority Data
Jan. 11, 2019 (JP) 2019-003592

(51) Int. Cl. G10L 15/22; G08B 21/18

(52) U.S. Cl. CPC G10L 15/22; G10L 2015/223; G08B 21/18

(57) ABSTRACT

A method conducted by a control device which controls an apparatus based on contents of user's speech, the method including: detecting a change in a state of at least one of a plurality of apparatuses; identifying a control target apparatus from among the plurality of apparatuses based on first information indicative of the change in the state; and in a case where the control target apparatus is identified, starting voice acceptance processing of accepting voice of the user by using a sound collecting device, and outputting a notification for urging a user to make a speech related to the control target apparatus.

### TECHNICAL FIELD

The present disclosure relates to a technique for controlling an apparatus based on contents of user's speech.

### BACKGROUND ART

There is provided a system which checks a state of an electronic apparatus at home and operates the apparatus by using voice input. In such a system, for example, user's speech is obtained by a terminal provided with a microphone. The terminal provided with a microphone waits for input of a specific phrase (trigger word) determined in advance. When sensing input of a trigger word, the terminal starts voice recognition and transfers a voice signal indicative of user's speech subsequent to the trigger word to a voice processing system mounted on cloud. The voice processing system analyzes contents of user's speech based on the transferred voice signal to execute processing based on an analysis result. This realizes state check and operation of an electronic apparatus.

Patent Literature 1 discloses a technique of acquiring voice by sensing occurrence of a predetermined event as a trigger of start of voice acquisition, and notifying a user of the start of voice acquisition.

In a case where a plurality of controllable apparatuses are present, a user needs to speak information (an installation place, a control target apparatus name, etc.) for identifying a control target apparatus and control contents. However, in a case of occurrence of such a physical event of setting a food material or laundry as cooking food materials by a microwave oven or starting washing by a washing machine, a control target apparatus is obvious and it is troublesome for a user to newly speak for identifying the control target apparatus.

### CITATION LIST

### Patent Literature

Patent Literature 1: Japanese Unexamined Patent Publication No. 2017-004231

### SUMMARY OF INVENTION

The present disclosure has been made in order to solve the above-described problem, and an object of the present disclosure is to provide a method of accepting user's speech regarding a control target apparatus without causing a user to make a speech as a trigger of start of voice acceptance processing and make a speech for identifying a control target apparatus, a control device therefor, and a program thereof.

One aspect of the present disclosure is a method conducted by a control device which controls an apparatus based on contents of user's speech, the method including: detecting a state change of at least one of a plurality of apparatuses; identifying a control target apparatus from among the plurality of apparatuses based on first information indicative of the state change; and in a case the control target apparatus is identified, starting voice acceptance processing of accepting voice of a user by using a sound collecting device, as well as outputting a notification for urging the user to make a speech regarding the control target apparatus.

The present disclosure enables a system configuration in which a plurality of voice-controllable apparatuses are present to accept user's speech regarding a control target apparatus without causing a user to make a troublesome speech as a trigger of start of voice acceptance processing and make a speech for identifying the control target apparatus.

### BRIEF DESCRIPTION OF DRAWINGS

FIG. 1 is a block diagram showing one example of an overall configuration of a voice control system capable of controlling a plurality of apparatuses to be controlled by voice in a first embodiment.

FIG. 2 is a diagram showing one example of a data configuration of a voice dialog dictionary DB shown in FIG. 1.

FIG. 3 is a diagram showing one example of a data configuration of a start condition table shown in FIG. 1.

FIG. 4 is a diagram showing one example of a data configuration of a beam form table shown in FIG. 1.

FIG. 5 is a view showing a specific example of a control apparatus and an apparatus to be controlled arranged in a house layout in the first embodiment.

FIG. 6 is a flow chart showing one example of processing starting with determination of a start condition for voice acceptance processing until start of voice acceptance processing in the voice control system in the first embodiment.

FIG. 7 is a flow chart showing one example of processing executed when identifying a control command for a control target apparatus after the voice acceptance processing is started in the voice control system in the first embodiment.

FIG. 8 is a block diagram showing one example of an overall configuration of a voice control system in a second embodiment.

FIG. 9 is a flow chart showing one example of processing starting with determination of a start condition for voice acceptance processing until start of voice acceptance processing in the voice control system in the second embodiment.

FIG. 10 is a flow chart continued from FIG. 9.

FIG. 11 is a flow chart showing one example of processing executed when identifying a control command for a control target apparatus after the voice acceptance processing is started in the voice control system in the second embodiment.

FIG. 12 is a flow chart continued from FIG. 11.

### DESCRIPTION OF EMBODIMENTS

(Knowledge on which the Present Disclosure is Based)

A control device has been considered which controls an electronic apparatus by executing voice recognition processing of recognizing voice of user's speech and analyzing a voice recognition result. In such a control device, when the voice recognition processing is constantly activated, a user might feel uneasy about having his/her conversation being heard by an outsider. Additionally, when the voice recognition processing is constantly activated, an electronic apparatus might be erroneously operated by unintended voice. Under these circumstances, in such a control device, it is a common practice to start voice recognition processing on condition that a specific phrase (trigger word) is spoken. However, it is troublesome for a user to speak a trigger word every time the voice recognition processing is started.

In order to cope with such a problem, the technique according to the above-described Patent Literature 1 intends to prevent a user from troublesome speaking of a trigger word each time and prevent a user from feeling uneasy about having his/her conversation being heard by others by starting voice recognition processing upon sensing of a predetermined event, and notifying a user of the start of the voice recognition processing by voice.

However, the technique of Patent Literature 1 is premised on that a voice dialog interface is mounted on a specific electronic apparatus but not on that one control device controls a plurality of electronic apparatuses. Therefore, the technique of Patent Literature 1 does not have a configuration in which after the voice recognition processing is started, an electronic apparatus as a control target cannot be identified from among a plurality of electronic apparatuses.

In a case where one control device controls a specific electronic apparatus by voice among a plurality of electronic apparatuses, a control target apparatus should be identified. For example, in a case where there are a plurality of electronic apparatuses of the same kind, such as two air conditioners, a control target apparatus should be identified. In a case where there are a plurality of electronic apparatuses of different kinds which are operable with the same speech phrase, when, for example, speech “warm” is made, while an air conditioner starts heating operation, a microwave oven also starts warming operation. A control target apparatus should be therefore identified.

In a case where a predetermined event in the technique of Patent Literature 1 is, for example, setting a food material on a microwave oven, an electronic apparatus that a user wants to control is considered to be a microwave oven.

However, in a case where an air conditioner and a microwave oven are included as controllable electronic apparatuses, just by the speech of “warm”, a control device cannot identify which of the microwave oven and the air conditioner is a control target. It is therefore necessary to execute dialog processing for identifying an electronic apparatus to be a control target, which is troublesome for both a user and the control device.

There has been given no consideration to a technique of starting voice recognition by sensing a predetermined event in a control device which controls, among a plurality of controllable electronic apparatuses, a specific electronic apparatus by voice, identifying an electronic apparatus as a control target, and accepting user's speech related to the identified electronic apparatus.

In order to solve the foregoing problems, one aspect of the present disclosure is a method conducted by a control device which controls an apparatus based on contents of user's speech, the method including: detecting a state change of at least one of a plurality of apparatuses; identifying a control target apparatus from among the plurality of apparatuses based on first information indicative of the state change; and in a case where the control target apparatus is identified, starting voice acceptance processing of accepting voice of a user by using a sound collecting device, and outputting a notification for urging the user to make a speech related to the control target apparatus.

According to the configuration, the voice acceptance processing is started after detection of a state change of an apparatus and identification of a control target apparatus from among a plurality of apparatuses based on the first information indicative of the state change, and a notification for urging a user to make a speech related to the control target apparatus is output. Therefore, the present configuration enables a control target apparatus to be identified from among a plurality of apparatuses to start the voice acceptance processing and accept a speech related to the control target apparatus without causing a user to make a troublesome speech such as speech as a trigger of start of the voice acceptance processing and make a speech for identifying a control target apparatus.

In the above configuration, the notification may be fourth information including second information corresponding to the control target apparatus and third information indicative of at least a part of control contents for the control target apparatus.

According to the present configuration, since upon start of the voice acceptance processing, the fourth information is output which includes the second information corresponding to the control target apparatus and the third information indicative of a part of control contents for the control target apparatus, it is possible to reliably notify a user of which apparatus is a control target apparatus and that the control target apparatus is in a control acceptable state.

In the above configuration, the state change may be detected based on a sensor value obtained from a sensor provided in some of the plurality of apparatuses.

According to the present configuration, since a state change is detected based on a sensor value obtained from the sensor provided in the plurality of apparatuses, a state change of the apparatus can be detected precisely.

In the above configuration, further, in a case where after the voice acceptance processing is started, a state where the control target apparatus is not controlled for a fixed period is detected, the voice acceptance processing may be resumed and the notification may be output.

According to the present configuration, since in a case where after the voice acceptance processing is started, a state where a control target apparatus is not controlled for a fixed period is detected, the voice acceptance processing is resumed and a notification urging a user to make a speech is output, when the user forgets to control the control target apparatus, the user can be reminded of the control.

In the above configuration, the notification may be fifth information which urges a speech for executing service related to the control target apparatus.

According to the present configuration, since the fifth information which urges a speech for executing service related to a control target apparatus is output, a range of a control target can be extended to service without being limited to apparatuses.

In the above configuration, the notification may be voice output from a voice output device.

According to the present configuration, a notification can be output through voice.

In the above configuration, the notification may be sound output from an electronic sound output device.

According to the present configuration, a user can be notified of start of the voice acceptance processing by such simple electronic sound as “Pee” and “Poon”. Accordingly, simple notification sound can reduce uneasiness of a user who feels troublesome when giving a notification by voice.

In the above configuration, the notification may be video output from a display.

While in a case of voice notification, when a user misses listening the notification, rechecking is not possible, the present configuration in which a notification is output as visual information can suppress user's overlook of a notification.

In the above configuration, the notification may be light output from a light emitting device.

According to the present configuration, a user can visually recognize start of the voice acceptance processing using light output from a light emitting device such as an LED.

In the above configuration, the sound collecting device is installed at a position different from a position of the control target apparatus, and in the voice acceptance processing, the sound collecting device may execute directivity control of directing directivity of a microphone to a direction predetermined relative to the control target apparatus.

According to the present configuration, sound of user's speech from a direction in which the user is likely to make a speech can be more appropriately collected.

In the above configuration, the direction predetermined may be decided based on a history of directions of sounds collected by the sound collecting device from voice of speech made by the user for controlling the control target apparatus.

According to the present configuration, since a direction of directivity of the sound collecting device is decided based on a history of directions in which a user made a speech when controlling the control target apparatus, a direction of directivity can be automatically calibrated to enable omission of user's setting.

In the above configuration, in identifying the control target apparatus, in a case where a first apparatus among the plurality of apparatuses changes to a given state and a second apparatus different from the first apparatus changes to a given state, at least one of the first apparatus and the second apparatus may be identified as the control target apparatus.

According to the present configuration, in a case, for example, where during operation of the first apparatus, the second apparatus interrupts and a user needs to change a state of the first apparatus in order to cope with the interruption, a user can be urged to make a speech for control of at least one of the first apparatus and the second apparatus. Also according to the present configuration, voice acceptance start processing can be started on condition of a change in a state of a plurality of apparatuses, for example, on condition of a state change of the first apparatus and a state change of the second apparatus.

Additionally, the present disclosure can be realized not only as a method of executing such a characteristic processing as described above but also as a control device including a processing unit for executing characteristic steps included in the method. It can be realized also as a computer program which causes a computer to execute each of characteristic steps included in such a method. Then, it goes without saying that such a computer program can be distributed via a computer-readable non-temporary recording medium such as a CD-ROM or via a communication network such as the Internet.

In the following, embodiments of the present disclosure will be described with reference to the accompanying drawings. The embodiments to be described below each show one specific example of the present disclosure. Numerical values, shapes, components, steps and orders of the steps shown in the following embodiments are each one example and are not construed to limit the present disclosure. Of the components in the following embodiments, a component not recited in an independent claim showing a most-significant concept will be described as an arbitrary component. Additionally, in every embodiment, the respective contents can be combined.

### First Embodiment

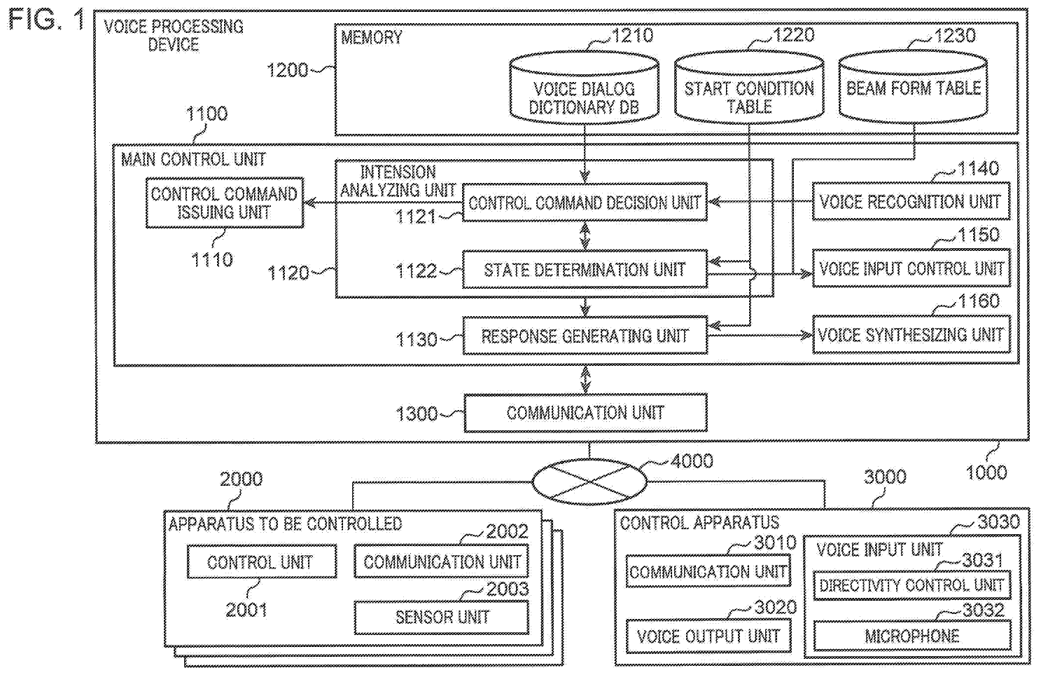

FIG. 1 is a block diagram showing one example of an overall configuration of a voice control system capable of controlling a plurality of apparatuses to be controlled 2000 by voice in a first embodiment. The voice control system shown in FIG. 1 includes a voice processing device 1000 (one example of a control device) connected to a network 4000, the apparatus to be controlled 2000 (one example of an apparatus), and a control apparatus 3000 (one example of an output unit, a voice output device, and a sound collecting device).

The voice processing device 1000 includes a main control unit 1100, a memory 1200, and a communication unit 1300. The main control unit 1100 is configured with, for example, a processor such as a CPU. The main control unit 1100 includes a control command issuing unit 1110, an intension analyzing unit 1120, a response generating unit 1130, a voice recognition unit 1140, a voice input control unit 1150, and a voice synthesizing unit 1160. Each block provided in the main control unit 1100 may be realized by execution of a program by a processor, or may be configured with a dedicated electrical circuit.

The intension analyzing unit 1120 includes a control command decision unit 1121 and a state determination unit 1122 (one example of a detection unit and an identification unit). The memory 1200 is configured with a semiconductor memory or a non-volatile memory such as a hard disk. The memory 1200 includes a voice dialog dictionary DB (data base) 1210, a start condition table 1220, and a beam form table 1230.

All the elements configuring the voice processing device 1000 may be mounted on a physical server connected to the network 4000 or may be mounted on a virtual server on cloud service or may be mounted on the same terminal as that of the control apparatus 3000. Further, at least one apparatus to be controlled 2000 out of the apparatuses to be controlled 2000 may have functions of the control apparatus 3000 and the voice processing device 1000, and every configuration that can be realized by combining these configurations can be adopted.

The control command issuing unit 1110 transmits a control command decided by the control command decision unit 1121 to the apparatus to be controlled 2000 identified as a control target apparatus via the communication unit 1300.

The control command decision unit 1121 obtains text data as a voice recognition result from the voice recognition unit 1140 and analyzes syntax of the obtained text data to identify a word or the like included in text data. Then, by collating the analysis result with the voice dialog dictionary DB 1210 preserved in the memory 1200, the control command decision unit 1121 decides control contents for a control target apparatus identified by the state determination unit 1122 and outputs the control contents to the control command issuing unit 1110.

The state determination unit 1122 obtains a sensor value detected by a sensor unit 2003 of the apparatus to be controlled 2000 via the communication unit 1300 and collates the obtained sensor value with the start condition table 1220 to determine whether or not there exists an apparatus to be controlled 2000 which satisfies start conditions for voice acceptance processing among the plurality of apparatuses to be controlled 2000. Then, when determining that there exists the apparatus to be controlled 2000 which satisfies the start conditions for the voice acceptance processing, the state determination unit 1122 identifies the apparatus to be controlled 2000 as a control target apparatus and outputs an apparatus ID of the control target apparatus to each of the voice input control unit 1150, the response generating unit 1130, and the control command decision unit 1121.

When a control target apparatus is identified by the state determination unit 1122, the response generating unit 1130 generates text data of a response sentence for urging a user to make a speech for controlling the control target apparatus and outputs the text data to the voice synthesizing unit 1160. Here, a response sentence for urging a user to make a speech for controlling a control target apparatus, for example, “A food material has been put into a cooking range. How would you like to control the apparatus?”, includes “range” as information corresponding to a control target apparatus, and “How would you like to control the apparatus?” as information indicative of at least a part of control contents of the control target apparatus. Here, the information corresponding to a control target apparatus is one example of second information, for which information indicative of a control target apparatus can be adopted. The information indicative of at least a part of control contents of a control target apparatus is one example of third information. The response sentence is one example of fourth information. The third information indicative of at least a part of control contents of a control target apparatus may be, for example, information indicative of a control content itself such as “Start cooking range warming operation?”, or information including a state of a control target apparatus such as “A food material has been put into a cooking range.”, or may be a message euphemistically inquiring about a control method such as “How would you like to control the apparatus?”. Further, as the information indicative of a control content itself, such a message can be adopted which inquires about control contents in a selection form, for example, “Start warming operation, start unfreezing operation, or start oven operation?”.

Additionally, when control contents for a control target apparatus are decided by the control command decision unit 1121, the response generating unit 1130 generates text data of a response sentence to the effect that the control contents are decided and outputs the text data to the voice synthesizing unit 1160. Further, when determination is made by the control command decision unit 1121 that repeating a question is necessitated by lack of information for identifying control contents, the response generating unit 1130 generates text data of a response sentence for repeating a question and outputs the text data to the voice synthesizing unit 1160.

The voice recognition unit 1140 converts a voice signal obtained from a voice input unit 3030 of the control apparatus 3000 via the communication unit 1300 into text data and outputs the converted text data as a voice recognition result to the control command decision unit 1121.

When a control target apparatus is identified by the state determination unit 1122, the voice input control unit 1150 transmits a control command for instructing on start of the voice acceptance processing to the control apparatus 3000 via the communication unit 1300. The control apparatus 3000 responsively starts the voice acceptance processing to accept user's speech for controlling a control target apparatus. The voice input control unit 1150 may also refer to the beam form table 1230 to obtain a beam form direction corresponding to the identified control target apparatus, and transmit the beam form direction in combination with the control command for instructing on start of the voice acceptance processing.

The voice synthesizing unit 1160 obtains text data of a response sentence generated by the response generating unit 1130 and executes voice synthesizing processing to generate a response voice signal and transmit the response voice signal to the control apparatus 3000 via the communication unit 1300.

The communication unit 1300 is configured with a communication circuit which connects the voice processing device 1000 to the network 4000. The communication unit 1300 causes the voice processing device 1000 to be connected with the apparatus to be controlled 2000 and the control apparatus 3000 via the network 4000 so as to be communicable with each other. Specifically, the communication unit 1300 transmits, to the control apparatus 3000, a control command for instructing on start of the voice acceptance processing, a control command for controlling the apparatus to be controlled 2000, a response voice signal, etc. The communication unit 1300 also receives a sensor value detected by the sensor unit 2003 of the apparatus to be controlled 2000 and a voice signal obtained by the control apparatus 3000.

The apparatus to be controlled 2000 includes a control unit 2001, a communication unit 2002, and the sensor unit 2003. The apparatus to be controlled 2000 is configured with remote-controlled apparatuses which are connected to the network 4000, for example, household appliances such as a microwave oven, an IH cooker, and an air conditioner, AV (audio visual) apparatuses such as a television set and a recorder, residential apparatuses such as a door intercom, and communication apparatuses such as a wired phone and a smart phone.

The control unit 2001 is configured with a computer including, for example, a CPU and a memory and executes a control command for controlling the apparatus to be controlled 2000, the control command being received by the communication unit 2002.

The communication unit 2002 is configured with a communication circuit which connects the apparatus to be controlled 2000 to the network 4000, and notifies a sensor value obtained by the sensor unit 2003 to the state determination unit 1122 of the voice processing device 1000 via the network 4000. The communication unit 2002 also receives a control command transmitted from the control command issuing unit 1110 via the communication unit 1300.

The sensor unit 2003 is configured with an arbitrary sensor such as a temperature sensor and an opening/closing sensor, for which different sensors are adopted that vary with a kind of the apparatus to be controlled 2000 or a state to be determined. The opening/closing sensor is, for example, a gyro sensor or an acceleration sensor. The sensor unit 2003 may be configured with one or a plurality of sensors mounted on the apparatus to be controlled 2000, or configured with one or a plurality of sensors arranged apart from the apparatus to be controlled 2000. In a case of, for example, an air conditioner, a temperature sensor which detects indoor and outdoor temperatures, and temperatures of a refrigerant and the like is adopted as the sensor unit 2003, and in a case of a refrigerator, an opening/closing sensor which detects opening/closing of a door, a temperature sensor which detects temperature inside the refrigerator, and the like are adopted as the sensor unit 2003.

The control apparatus 3000 includes a communication unit 3010, a voice output unit 3020, and the voice input unit 3030. The voice input unit 3030 includes a directivity control unit 3031 and a microphone 3032. The control apparatus 3000 is a voice output device having a sound collecting function such as a smart speaker, or a portable terminal having a sound collecting function and a voice output function such as a smart phone. The control apparatus 3000 can be configured to be included in the apparatus to be controlled 2000. In such a configuration, for example, the function of the control apparatus 3000 is mounted on a specific apparatus to be controlled 2000 among the plurality of apparatuses to be controlled 2000, so that the specific apparatus to be controlled 2000 takes charge of the function of the control apparatus 3000. The control apparatus 3000 may be configured with a desk-top computer.

The communication unit 3010 transmits a voice signal obtained by the voice input unit 3030 to the voice processing device 1000, and receives a control command and a response voice signal which cause start of the voice acceptance processing.

The voice output unit 3020, which is, for example, a speaker that converts a voice signal obtained by the voice input unit 3030 into voice and outputs the voice to an outside space, reproduces a response voice signal transmitted from the voice processing device 1000.

The microphone 3032 of the voice input unit 3030 collects, for example, voice of user's speech and converts the voice into a voice signal. In the present embodiment, for enabling directivity control, the microphone 3032 is configured with an array microphone composed of a plurality of microphones. When no directivity control is conducted, the microphone 3032 is configured with one microphone. When obtaining a beam form direction transmitted from the voice input control unit 1150 of the voice processing device 1000, the directivity control unit 3031 executes directivity control of directing directivity of the microphone 3032 to the beam form direction.

The network 4000 is an arbitrary network such as an optical fiber line, a radio line or a public telephone line. For example, in a case where the voice processing device 1000, the apparatus to be controlled 2000, and the control apparatus 3000 are installed indoors, the network 4000 can be a home local network separated from an external network such as the Internet. In a case where the voice processing device 1000 and the apparatus to be controlled 2000 are installed indoors and the voice processing device 1000 is configured with a cloud server, the network 4000 can include an external network and a home local network connected to the external network.

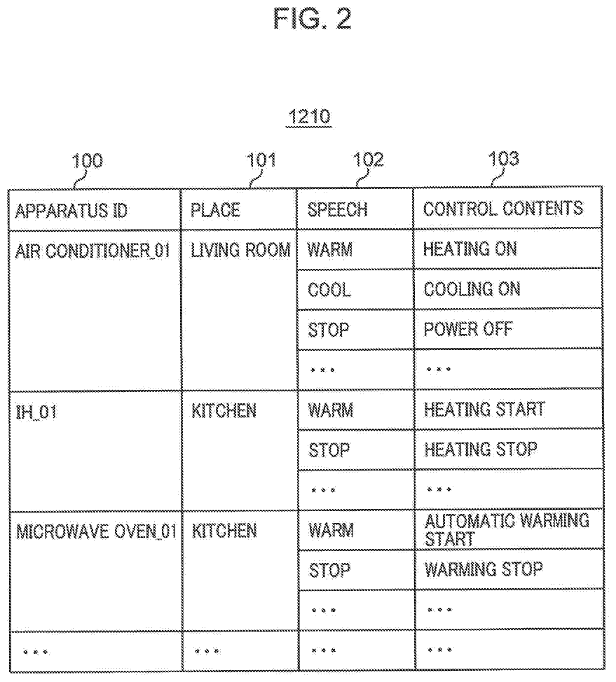

FIG. 2 is a diagram showing one example of a data configuration of the voice dialog dictionary DB 1210 shown in FIG. 1. As shown in FIG. 2, the voice dialog dictionary DB 1210 has an apparatus ID column 100, a place column 101, a speech column 102, and a control contents column 103, in which each of the apparatuses to be controlled 2000 is stored to be associated with an apparatus ID, a place, a speech, and control contents. At the identification of a control command for controlling the apparatus to be controlled 2000 from user's speech, the voice dialog dictionary DB 1210 is referred to by the control command decision unit 1121. An apparatus ID represents an identifier which uniquely identifies an apparatus to be controlled 2000. An apparatus ID is, for example, “air conditioner_01” in a case of an air conditioner and is “IH_01” in a case of an IH cooker. Place represents an installation place of the apparatus to be controlled 2000 in, for example, a living room or a kitchen. Speech represents speech contents for controlling the apparatus to be controlled 2000, such as “Warm” and “Cool”. The control contents represent control contents of the apparatus to be controlled 2000 corresponding to such speech as “Heating ON” and “Cooling ON”. For example, an air conditioner starts heating operation in response to the speech “Warm” and starts cooling operation in response to the speech “Cool”.

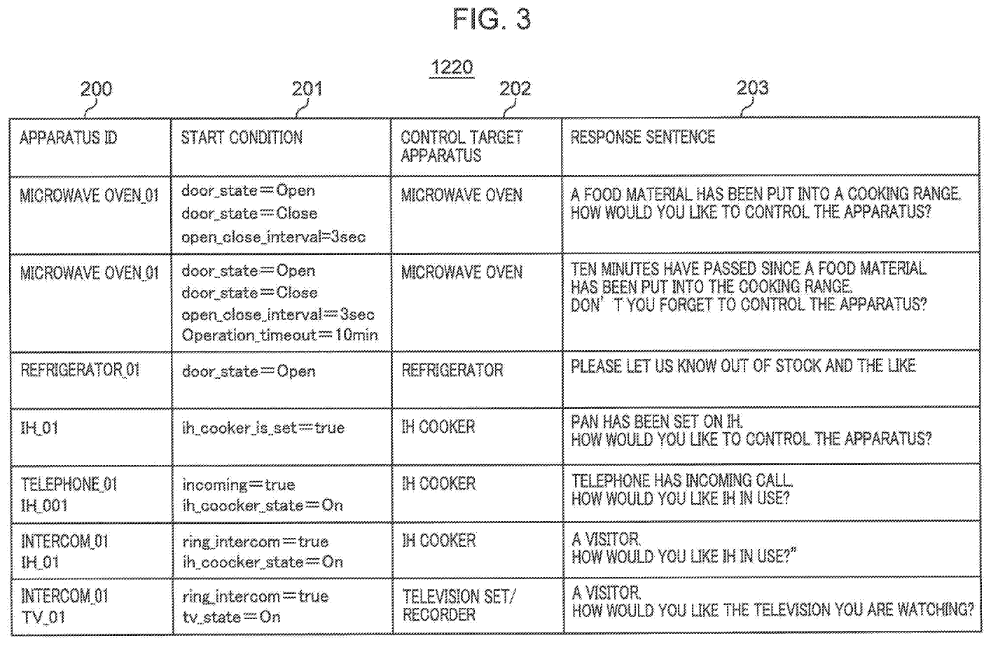

FIG. 3 is a diagram showing one example of a data configuration of the start condition table 1220 shown in FIG. 1. The start condition table 1220 is referred to when the state determination unit 1122 determines whether a start condition for the voice acceptance processing is satisfied or not. Details of the processing for determining whether a start condition is satisfied or not will be described later. As shown in FIG. 3, the start condition table 1220 has an apparatus ID column 200, a start condition column 201, a control target apparatus column 202, and a response sentence column 203, in which each of the apparatuses to be controlled 2000 is stored to be associated with an apparatus ID, a start condition, a control target apparatus, and a response sentence. An apparatus ID is the same as the apparatus ID shown in FIG. 2. A start condition represents a start condition for the voice acceptance processing. For example, in a microwave oven with an apparatus ID “microwave oven_01”, “door_state=Open, door_state=Close, open_close_interval=3 sec” is stored as a start condition. Accordingly, when a state change is detected in which a door has been brought into an open state and then brought into a closed state within three seconds, the microwave oven is determined to satisfy the start condition for the voice acceptance processing and is identified as a control target apparatus.

The control target apparatus column 202 is where there is stored an apparatus to be controlled 2000 which becomes a control target when all the conditions stored in the start condition column 201 are satisfied. Basically, in the control target apparatus column 202, there is stored an apparatus to be controlled 2000 whose apparatus ID is stored in the apparatus ID column 200. It is however possible that as shown in the fifth and sixth rows, one (for example, an IH cooker) of the plurality of apparatuses to be controlled 2000 stored in the ID column 201 may be stored, and as shown in the seventh row, an apparatus to be controlled 2000 (for example, a recorder) different from the plurality of apparatuses to be controlled 2000 stored in the apparatus ID column 201 may be stored.

A response sentence represents a response sentence output by voice from the control apparatus 3000 at the start of the voice acceptance processing. In a case, for example, where the microwave oven in the first row satisfies the start condition for the voice acceptance processing, a response voice “A food material has been put into a cooking range. “How would you like to control the apparatus?” is output from the control apparatus 3000 as a response sentence. This enables a user to confirm that the microwave oven is in a speech acceptable state.

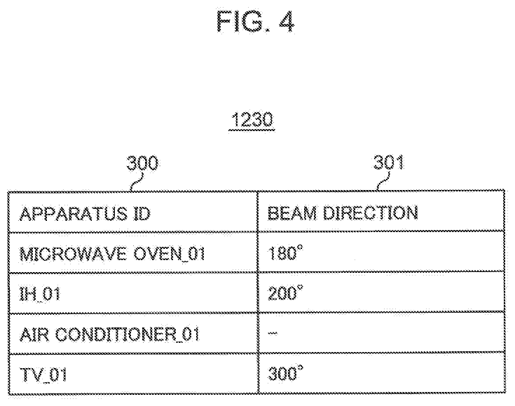

FIG. 4 is a diagram showing one example of a data configuration of the beam form table 1230 shown in FIG. 1. As shown in FIG. 4, the beam form table 1230 has an apparatus ID column 300 and a beam direction column 301, in which each apparatus to be controlled 2000 is stored so as to be associated with an apparatus ID and a beam form direction. An apparatus ID is the same as the apparatus ID shown in FIG. 2. A beam form direction represents an angle indicating a direction of directivity of the control apparatus 3000 when a reference direction of the control apparatus 3000 is set to be 0°, and takes a value, for example, from 0° to 359°.

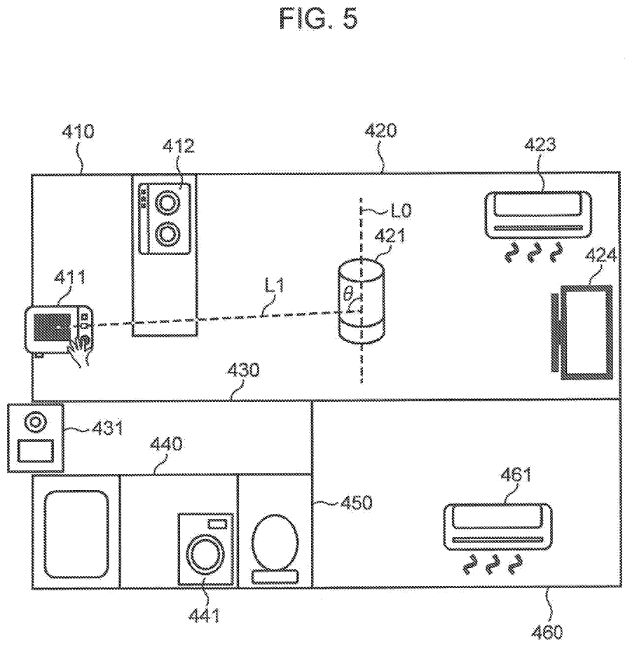

With reference to FIG. 5, description will be made of a method of deciding a beam form direction. The beam form direction is decided based on, for example, an installation position of the apparatus to be controlled 2000. In a case of, for example, a microwave oven 411, an angle θ formed by a straight line L1 connecting an installation position of the microwave oven 411 and an installation position of a smart speaker 421 as the control apparatus 3000 and a reference direction L0 is decided as a beam form direction. The reference direction L0 is a given direction passing through the installation position of the smart speaker 421 and parallel to a floor surface. A beam form direction stored in the beam form table 1230 is input by a user or a worker at the time of, for example, installation of the apparatus to be controlled 2000 by using an input device such as a smart phone and is transmitted to the voice processing device 1000.

The beam form direction can be calibrated according to a direction in which the apparatus to be controlled 2000 is often controlled by voice. A calibration method is, for example, a method of designating a beam form direction by a user using a setting application of a smart phone or the like. In this case, after obtaining a beam form direction designated by a user regarding a certain apparatus to be controlled 2000, the main control unit 1100 of the voice processing device 1000 need only update a beam form direction of the apparatus to be controlled 2000 stored in the beam form table 1230 by the obtained beam form direction.

A calibration direction can be decided, for example, based on a history of directions of sounds collected by the smart speaker 421 when controlling a certain apparatus to be controlled 2000 by voice. In this case, the smart speaker 421 transmits, to the voice processing device 1000, a voice signal indicative of user's voice collected when the apparatus to be controlled 2000 is controlled by voice in a manner that a sound collection signal is included in the voice signal, the sound collection signal associating a direction in which voice has been collected with an apparatus ID of the apparatus to be controlled 2000 which has been controlled. The voice processing device 1000 having received the voice signal accumulates sound collection information associated with voice information in the memory 1200 as a history. On the other hand, the main control unit 1100, when the number of pieces of sound collection information accumulated in the memory 1200 regarding a certain apparatus to be controlled 2000 is increased by a given number, need only calculate an average value of directions included in a latest given number of pieces of sound collection information, and update a beam form direction of a relevant apparatus to be controlled 2000 in the beam form table 1230 by the calculated average value as a new beam form direction.

FIG. 5 is a view showing a specific example of the control apparatus 3000 and the apparatus to be controlled 2000 arranged in a house layout in the first embodiment. In the following, description will be made of an operation example of the control apparatus 3000 and the apparatus to be controlled 2000 arranged in the house layout shown in FIG. 5. The house layout shown in FIG. 5 is configured with a kitchen 410, a living/dining room 420, an entrance/passage 430, a sanitary room/bath room 440, a toilet 450, and a bed room 460. In the kitchen 410, the microwave oven 411 and an IH cooker 412 are installed. In the living/dining room 420, the smart speaker 421 (one example of the control apparatus 3000), an air conditioner 423, and a television set 424 are installed. In the entrance/passage 430, a door intercom 431 is installed. In the sanitary room/bath room 440, a washing machine 441 is installed. In the bed room 460, an air conditioner 461 is installed.

It is assumed, for example, that a user opens a door of the microwave oven 411 and closes the door within three seconds after putting a food material into the oven. At this time, an opening/closing sensor of the microwave oven 411 sequentially transmits a sensor value of a state where the door is opened and a sensor value of a state where the door is closed within three seconds to the voice processing device 1000. The voice processing device 1000 having received the sensor value refers to the start condition table 1220 and finds that the microwave oven 411 satisfies a start condition for the voice acceptance processing to identify the microwave oven 411 as a control target apparatus. At this time, the voice processing device 1000 transmit, to the smart speaker 421, a response voice signal indicative of a response sentence “A food material has been put into a cooking range. How would you like to control the apparatus?” of the microwave oven 411 stored in the start condition table 1220 shown in FIG. 3. Also, at this time, the voice processing device 1000 refers to the beam form table 1230 shown in FIG. 4, obtains a beam form direction corresponding to the microwave oven 411, and transmits the beam form direction to the smart speaker 421.

The smart speaker 421 responsively outputs a response voice indicated by the received response voice signal. Further, the smart speaker 421 conducts directivity control of directing directivity to the obtained beam form direction and starts the voice acceptance processing. At this time, in response to the user's speech, the voice processing device 1000 refers to an electronic dictionary for a microwave oven stored in the voice dialog dictionary DB 1210 shown in FIG. 2 to decide control contents. Accordingly, assuming, for example, that the user makes a speech “Warm”, a voice signal of the speech is transmitted from the smart speaker 421 to the voice processing device 1000 and a control command of “automatic warming start” is transmitted from the voice processing device 1000 to the microwave oven 411, so that the microwave oven 411 starts automatic warming operation.

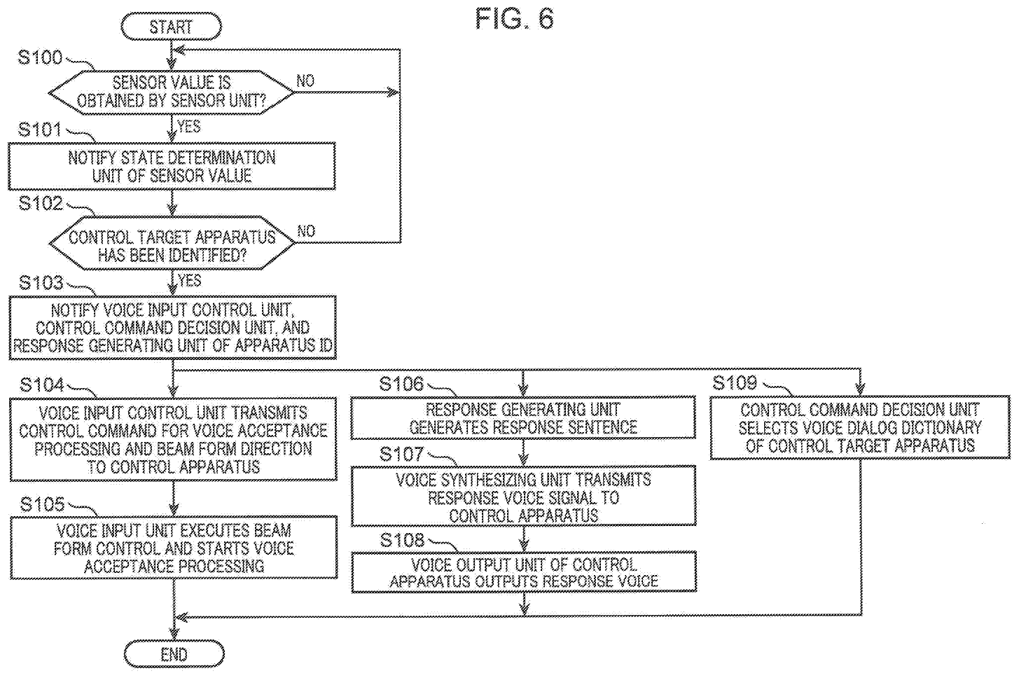

FIG. 6 is a flow chart showing one example of processing starting with determination of a start condition for the voice acceptance processing until start of the voice acceptance processing in the voice control system in the first embodiment.

First, when a sensor value indicative of the state of the apparatus to be controlled 2000 is obtained by the sensor unit 2003 of the apparatus to be controlled 2000 (S100: YES), the control unit 2001 of the apparatus to be controlled 2000 transmits the sensor value to the voice processing device 1000 via the communication unit 2002 in order to notify the state determination unit 1122 of the voice processing device 1000 of the sensor value (S101). Here, the apparatus to be controlled 2000 may transmit a sensor value in a case of a state change or may periodically transmit a sensor value in an arbitrary cycle.

The control unit 2001 of the apparatus to be controlled 2000 may also adopt a mode of transmitting a sensor value in a case of a state change and a mode of periodically transmitting a sensor value according to a kind of a sensor having detected a state and according to a configuration of the apparatus to be controlled 2000. An apparatus ID of the apparatus to be controlled 2000 as a transmission source is associated with a sensor value.

In a case where no sensor value is obtained by the sensor unit 2003 (S100: NO), the sensor unit 2003 enters a state of waiting for acquisition of a sensor value.

Next, the state determination unit 1122 collates the obtained sensor value with the start condition table 1220 to determine whether a control target apparatus has been identified or not (S102). In a case where no control target apparatus has been identified (S102: NO), the processing shifts to S100, so that the sensor unit 2003 again enters the state of waiting for acquisition of a sensor value. By contrast, in a case where a control target apparatus has been identified (S102: YES), the processing shifts to S103.

In a case, for example, where a sensor value of the apparatus ID “microwave oven_01” is obtained, records in the first row and the second row of the start condition table 1220 are extracted, and the start condition column 201 of each of the extracted records is referred to. Here, assuming that the obtained sensor value represents “door_state=Close” indicating that the door of the microwave oven entered a closed state and represents “door_state=Open” indicating that the door of the microwave oven entered an open state within three seconds from the present time point, since all the conditions stored in the start condition column 201 in the first row are satisfied, the microwave oven stored in the control target apparatus column 202 in the first row is identified as a control target apparatus. By contrast, in a case where among the conditions stored in the start condition column in the first row, only “door_state=Open” is obtained, the start condition is put on hold. In a case where “door_state=Close” is yet to be obtained at a time point after a lapse of three seconds from the time point of acquisition of “door_state=Open”, the holding is reset.

In S103, the state determination unit 1122 outputs the apparatus ID of the control target apparatus identified in S102 to the voice input control unit 1150, the control command decision unit 1121, and the response generating unit 1130. In a case, for example, where a microwave oven with the apparatus ID “microwave oven_01” is identified as a control target apparatus, the apparatus ID “microwave oven_01” is output to the voice input control unit 1150, the control command decision unit 1121, and the response generating unit 1130. Processing in S104 and S105, processing in S106 to S108 and processing in S109 shown below are conducted in parallel to each other.

In S104, the voice input control unit 1150 transmits the control command for instructing on start of the voice acceptance processing and a beam form direction to the control apparatus 3000 via the communication unit 1300. In detail, the voice input control unit 1150 refers to the apparatus ID column 300 of the beam form table 1230, extracts a record matching the output apparatus ID, and obtains a beam form direction stored in the column 301 of the extracted record as a beam form direction of the control target apparatus. Then, the voice input control unit 1150 transmits the obtained beam form direction in combination with the control command for instructing on start of the voice acceptance processing to the control apparatus 3000 via the communication unit 1300.

Next, the directivity control unit 3031 of the voice input unit 3030 of the control apparatus 3000 executes the directivity control to direct directivity of the microphone 3032 to the received beam form direction, and starts the voice acceptance processing (S105).

In S106, the response generating unit 1130 generates text data of a response sentence urging a user to control a control target apparatus by obtaining, from the start condition table 1220, a response sentence corresponding to a control target apparatus indicated by the output apparatus ID (S106). Assuming, for example, that the apparatus ID “microwave oven_01” is output from the state determination unit 1122, the response generating unit 1130 obtains text data of the response sentence “A food material has been put into a cooking range. How would you like to control the apparatus?” stored in the response sentence column 203 in the first row of the start condition table 1220. The obtained text data of the response sentence is output to the voice synthesizing unit 1160.

Next, the voice synthesizing unit 1160 generates a response voice signal of the response sentence output through the voice synthesizing processing and transmits the generated response voice signal to the control apparatus 3000 via the communication unit 1300 (S107).

Next, the voice output unit 3020 of the control apparatus 3000 outputs a response voice indicated by the response voice signal (S108). In the example of the above microwave oven, the response voice “A food material has been put into a cooking range. How would you like to control the apparatus?” is output from the voice output unit 3020. As a result, the user determines that his/her action of putting a food material into the microwave oven has brought the microwave oven to enter a control waiting state, and is allowed to confirm that the microwave oven can be controlled by making a speech by voice after this.

In S109, the control command decision unit 1121 selects a voice dialog dictionary of the control target apparatus indicated by the notified apparatus ID from the voice dialog dictionary DB 1210 (S109). Assuming, for example, that the microwave oven with the apparatus ID “microwave oven_01” is a control target apparatus, a voice dialog dictionary of the apparatus ID″ microwave oven_01″ is selected from the voice dialog dictionary DB 1210. This prevents occurrence of such situations as erroneously, the air conditioner starts heating operation or the IH cooker starts heating when a user speaks “Warm” to the microwave oven.

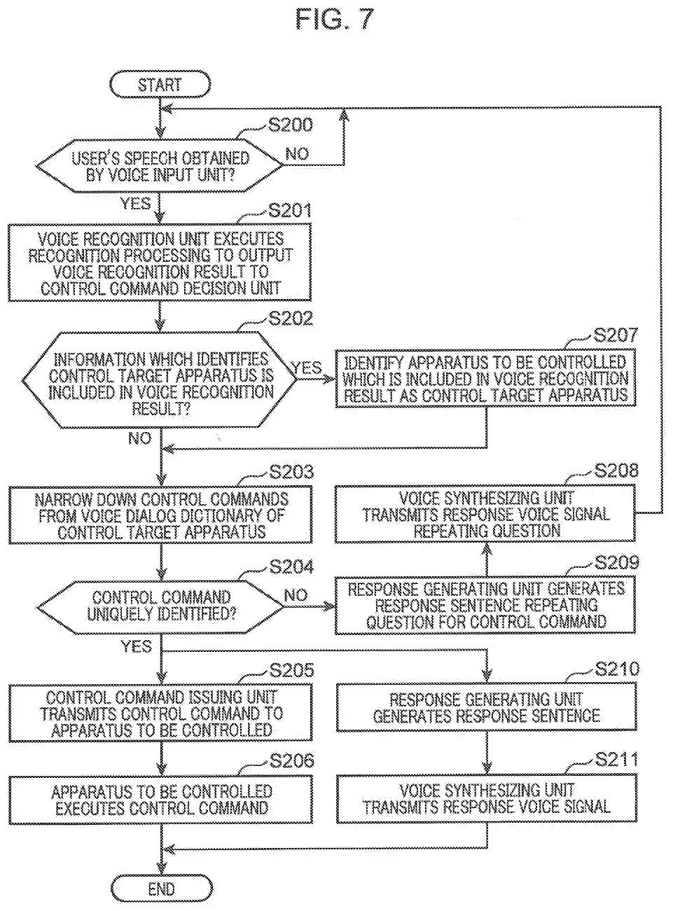

FIG. 7 is a flow chart showing one example of processing executed when identifying a control command for a control target apparatus after the voice acceptance processing is started in the voice control system in the first embodiment. When a voice signal indicative of user's speech is obtained by the voice input unit 3030 (S200: YES), the control apparatus 3000 transmits the obtained voice signal to the voice processing device 1000 via the communication unit 3010. The voice signal is obtained by the voice recognition unit 1140.

Next, the voice recognition unit 1140 executes voice recognition processing to convert the obtained voice signal into text data and outputs the converted text data to the control command decision unit 1121 as a voice recognition result (S201). On the other hand, while no voice signal indicative of user's speech is obtained, the voice input unit 3030 enters a voice signal acquisition waiting state (S200: NO).

Next, the control command decision unit 1121 determines whether the voice recognition result includes information which identifies the apparatus to be controlled 2000 or not. Here, the information which identifies the apparatus to be controlled 2000 is, for example, an apparatus name of a certain apparatus to be controlled 2000. In a case where information which identifies a control target apparatus is included (S202: YES), the control command decision unit 1121 decides, as a control target apparatus, the apparatus to be controlled 2000 included in the voice recognition result in place of the apparatus to be controlled 2000 identified as a control target apparatus in S102 in FIG. 6 (S207) and advances the processing to S203.

A case where determination of YES is made in S202 is a case, for example, where after the microwave oven is identified as a control target apparatus in S102 in FIG. 6, and the voice acceptance processing is started, the user makes a speech of “Air conditioner, warm.” In this case, the latest user's speech is esteemed to identify not a microwave oven but an air conditioner as a control target apparatus.

By contrast, in a case where information which identifies the apparatus to be controlled 2000 is not included in the voice recognition result (S202: NO), the control command decision unit 1121 narrows down control commands by collating the voice recognition result obtained in S201 with the voice dialog dictionary of the control target apparatus identified in S102 in FIG. 6 (S203). Assuming, for example, that the control target apparatus is a microwave oven with the apparatus ID “microwave oven_01”, control commands are narrowed down from the voice dialog dictionary of the apparatus ID “microwave oven_01” in the voice dialog dictionary DB 1210.

In a case where a control command is uniquely identified by the control command decision unit 1121 (S204: YES), the control command issuing unit 1110 transmits the uniquely identified control command to the control target apparatus via the communication unit 1300 (S205).

Next, the control unit 2001 of the apparatus to be controlled 2000 as a control target apparatus executes the transmitted control command (S206). As a result of the execution, assuming, for example, that the control target apparatus is a microwave oven and the user speaks “Warm”, operation of warming a food material will be executed by the microwave oven.

By contrast, in a case where no control command has been uniquely identified by the control command decision unit 1121 (S204: NO), the response generating unit 1130 generates text data of a response sentence repeating a question that asks a user to make a speech for voice control of the control target apparatus. As a response sentence repeating a question, a message repeating a question that asks for control contents of the control target apparatus can be adopted such as “How would you like to control the apparatus?”. A case where a control command cannot be uniquely identified corresponds, for example, to a case where the voice recognition result obtained in S201 includes none of speeches stored in the speech column 102 in the voice dialog dictionary of the control target apparatus.

Next, the voice synthesizing unit 1160 generates a response voice signal of a response sentence repeating a question and transmits the response voice signal to the control apparatus 3000 via the communication unit 1300 (S208). As a result, such a message as “How would you like to control the apparatus?” is output by voice from the voice output unit 3020 of the control apparatus 3000. After the end of the processing of S208, the processing shifts to S200.

Meanwhile, in S210, the response generating unit 1130 generates text data of a response sentence indicative of control contents indicated by the control command uniquely identified in S204 (S210). The response sentence indicative of control contents is a response sentence such as “Start warming of the cooking range.” Next, the voice synthesizing unit 1160 generates a response voice signal of the response sentence indicative of the control contents and transmits the response voice signal to the control apparatus 3000 via the communication unit 1300. In this manner, voice of a response sentence such as “Start warming of the cooking range.” is output from the voice output unit 3020 of the control apparatus 3000 (S211). As a result, the user is allowed to check whether the control target apparatus is controlled according to the user's speech or not.

As described in the foregoing, according to the first embodiment, the voice acceptance processing is started after a state change of the apparatus to be controlled 2000 is detected and a control target apparatus is identified from among the plurality of apparatuses to be controlled 2000 based on a sensor value indicative of the state change. Further, upon start of the voice acceptance processing, a response sentence urging a user to make a speech for controlling the control target apparatus is output by voice from the control apparatus 3000. Therefore, it is possible to identify a control target apparatus from among the plurality of apparatuses to be controlled 2000 and obtain user's speech for the control target apparatus without causing a user to make a troublesome speech such as a speech as a trigger of the voice acceptance processing and a speech for identifying a control target apparatus.

### Second Embodiment

In a second embodiment, in a case where it is detected that a control target apparatus has not been controlled for a fixed period after start of voice acceptance processing, the voice acceptance processing is resumed and a response sentence urging a user to make a speech for controlling the control target apparatus is output.

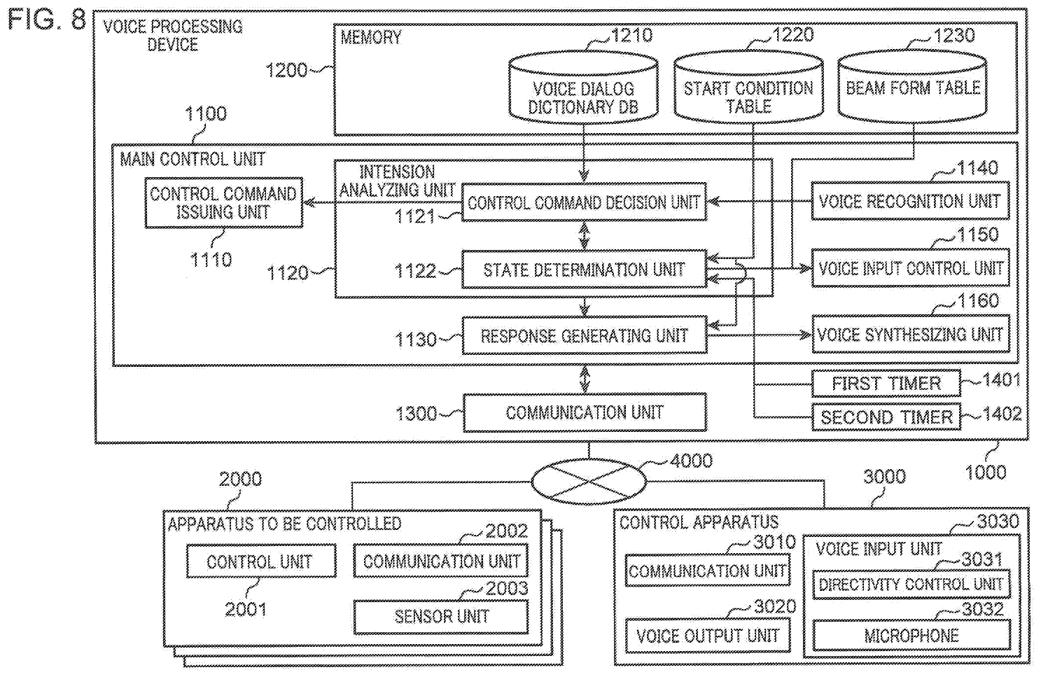

FIG. 8 is a block diagram showing one example of an overall configuration of a voice control system in the second embodiment. In FIG. 8, a difference from FIG. 1 is that the voice processing device 1000 further includes a first timer 1401 and a second timer 1402.

The first timer 1401 times a first period from start of the voice acceptance processing until the voice acceptance processing is resumed. The second timer 1402 times a second period as a time-out period of the voice acceptance processing. The first period is, for example, an expected period in which a user is highly likely to forget to make a speech for voice control of a control target apparatus after the voice acceptance processing is started. The second period is a period shorter than the first period.

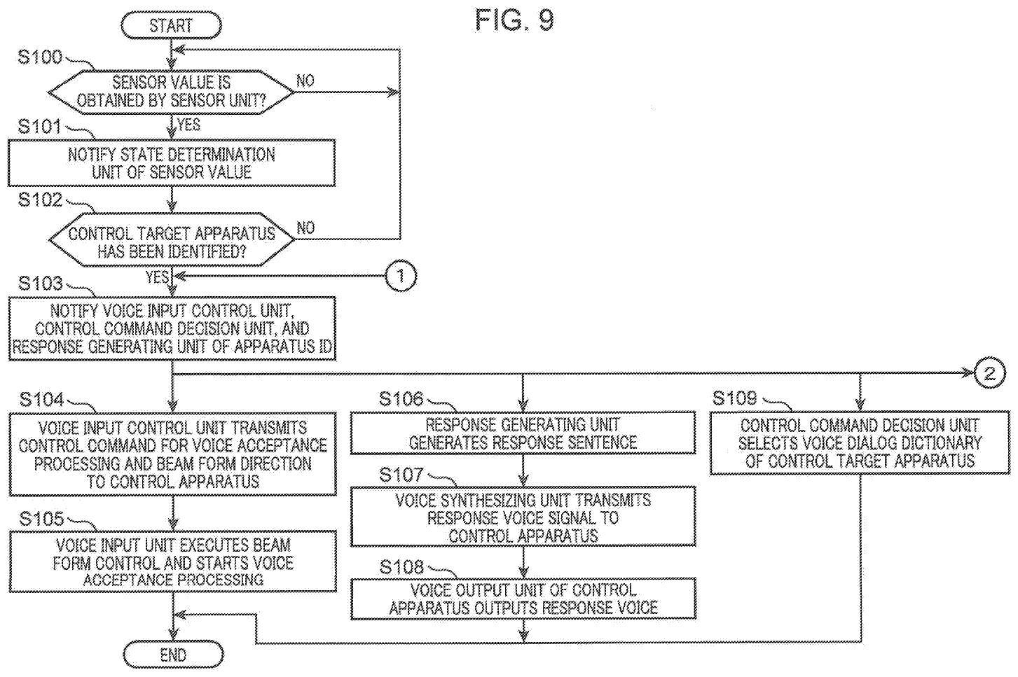

FIG. 9 is a flow chart showing one example of processing starting with determination of a start condition for the voice acceptance processing until start of the voice acceptance processing in the voice control system in the second embodiment. In FIG. 9, the same processing as in FIG. 6 is given the same step number. S100 to S109 shown in FIG. 9 are the same as S100 to S109 shown in FIG. 6. Through the processing shown in FIG. 9, a control target apparatus is identified to start the voice acceptance processing and a response sentence urging a user to make a speech is output.

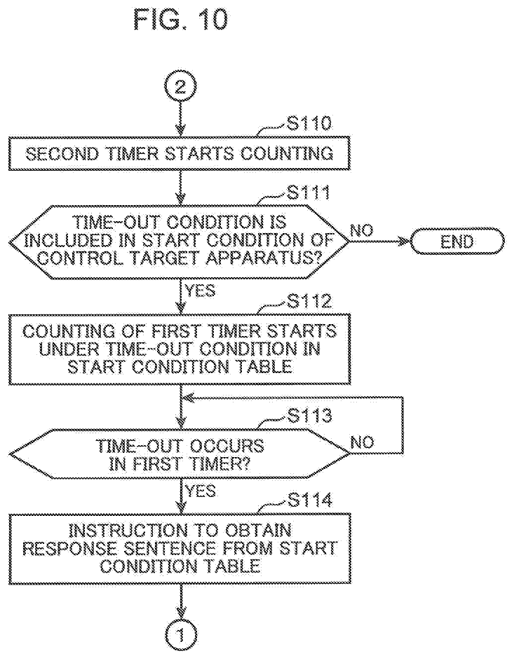

FIG. 10 is a flow chart continued from FIG. 9. Processing in S110 to S114 shown in FIG. 10 is conducted in parallel to the processing in S104 to S105, the processing in S106 to S108, and the processing in S109 shown in FIG. 9.

In S110, the state determination unit 1122 starts counting of the second timer 1402. In S111, the state determination unit 1122 refers to the start condition table 1220 and determines whether or not a time-out condition is included for the control target apparatus identified in S102. In a case where the time-out condition is included (S111: YES), time indicated by the time-out condition is set as the first period to start counting of the first timer 1401 (S112). By contrast, in a case where no time-out condition for the control target apparatus is included (S111: NO), the processing ends. In a case where the microwave oven is a control target apparatus in the example of FIG. 3, in the start condition column 201 in the second row, there is included “Operation_timeout=10 min” as a time-out condition in addition to “door_state=Open, door_state=Close, open_close_interval=3 sec”. Therefore, the first period is set to be ten minutes, and the first timer 1401 starts counting.

Next, the state determination unit 1122 determines whether the first period has elapsed to have time-out of the first timer 1401 or not (S113). In a case where time-out occurs in first timer 1401 (S113: YES), the state determination unit 1122 instructs the response generating unit 1130 to obtain a response sentence from the start condition table 1220 (S114). In the example of the microwave oven in the second row shown in FIG. 3, time-out of the first timer 1401 causes all the conditions stored in the start condition column 201 to be satisfied. The state determination unit 1122 responsively instructs the response generating unit 1130 to obtain a response sentence, so that the response generating unit 1130 obtains “Ten minutes have passed since a food material has been put into the cooking range. Don't you forget to control the apparatus?” as a response sentence in the second row. By contrast, in a case where the first timer 1401 is yet to have time-out (S113: NO), counting of the first timer 1401 is continued.

When S114 ends, the processing shifts to S103 in FIG. 9, and the processing in S104 to S105, the processing in S106 to S108, the processing in S109, and the processing in S110 to S114 will be again executed. In this case, the response sentence obtained in S114 is generated (S106), a response voice signal of the response sentence is transmitted to the control apparatus 3000 (S107), and a response voice of the response sentence is output from the control apparatus 3000 (S108). In this manner, a user is reminded of control. In a case where the processing in S110 to S114 in FIG. 10 is repeated by given times in order to avoid many times of repetition, the processing can be ended without shifting to S103 in FIG. 9. A case where the processing is repeated many times corresponds to a case, for example, where a user goes out after start of the voice acceptance processing.

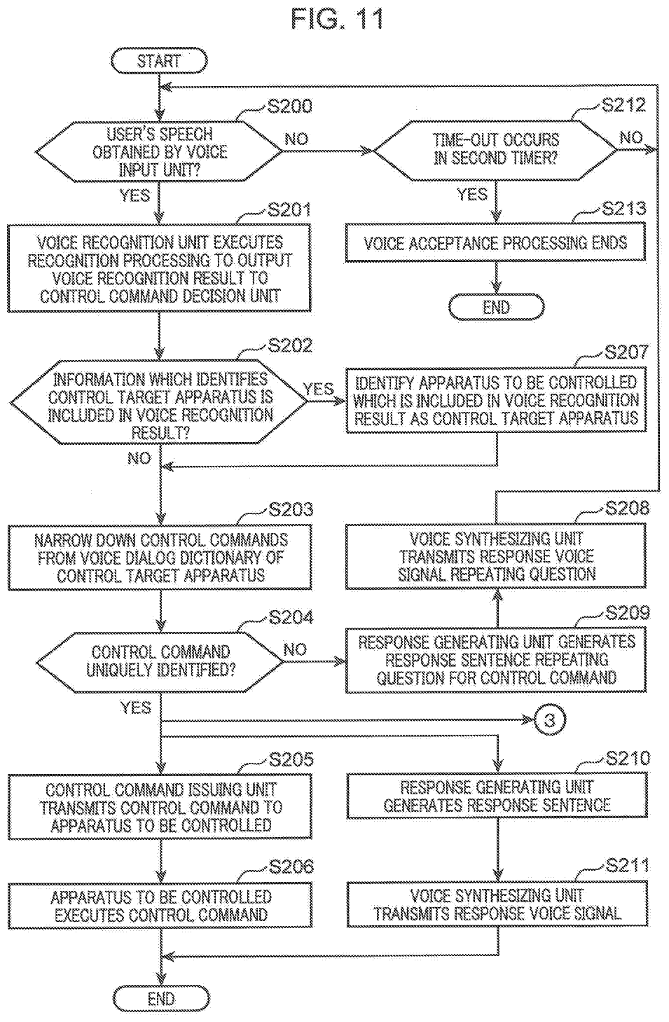

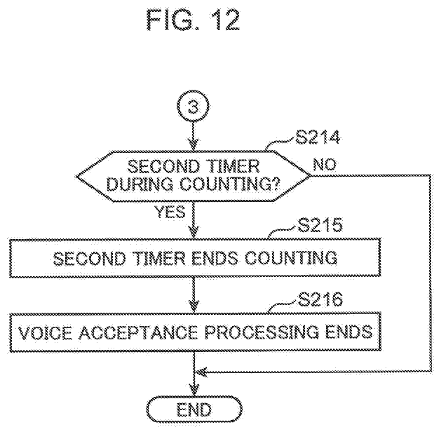

FIG. 11 is a flow chart showing one example of processing executed when identifying a control command for a control target apparatus after the voice acceptance processing is started in the voice control system in the second embodiment. In FIG. 11, the same processing as in FIG. 7 is given the same step number. In FIG. 11, differences from FIG. 7 are that the processing shifts to S212 subsequently to S200: NO, and that the processing shifts to S214 in FIG. 12 subsequently to S204: YES.

In a case where a voice signal indicative of user's speech is not obtained by the voice input unit 3030 (S200: NO), the state determination unit 1122 determines whether the second period has elapsed to have time-out of the second timer 1402 or not (S212). In a case where time-out occurs in the second timer 1402 (S212: YES), the state determination unit 1122 causes the voice acceptance processing to end (S213). In this case, the control command issuing unit 1110 issues a control command for instructing on end of the voice acceptance processing and transmits the control command to the control apparatus 3000 via the communication unit 1300. Upon receiving the control command, the control apparatus 3000 causes the voice input unit 3030 to end sound collection. In this manner, it is intended to prevent user's speech from constantly leaking outside.

By contrast, in a case where time-out does not occur in the second timer 1402 (S212: NO), the processing shifts to S200, so that the voice input unit 3030 enters a user's speech waiting state.

In a case where a control command is uniquely identified in S204 (S204: YES), the processing shifts to S214 shown in FIG. 12. FIG. 12 is a flow chart continued from FIG. 11. The processing in S214 to S216 is conducted in parallel to the processing in S205 to S206 and the processing in S210 to S211 shown in FIG. 11.

In S214, the state determination unit 1122 determines whether the second timer 1402 is during counting or not. In a case where the second timer 1402 is during counting (S214: YES), the state determination unit 1122 causes the second timer 1402 to end counting (S215). Next, the state determination unit 1122 causes the voice acceptance processing to end (S216). Specifically, since during counting of the second timer 1402, a control command has been uniquely identified by user's speech, the second timer 1402 is caused to end counting. In this case, a control command indicative of end of the voice acceptance processing is transmitted from the control command issuing unit 1110 to the control apparatus 3000. By contrast, in a case where the second timer 1402 is not during counting (S214: NO), the processing is ended.

According to the second embodiment, in a case where as a start condition for the voice acceptance processing, for example, after the microwave oven is opened/closed, the microwave oven is not controlled for a fixed period, the voice acceptance processing is resumed and a response sentence is output such as “Although a food material has been put into the cooking range, control does not seem to be started. Don't you forget to control the apparatus?”. This enables the voice acceptance processing to be resumed in a case where control is yet to be conducted at timing when a user is expected to conduct controlling, as well as enabling a user to check by a response sentence whether to forget to control a control target apparatus.

(Modifications)

The present disclosure can adopt modifications shown below.

(1) While in the above embodiments, the voice acceptance processing is started on condition that a food material has been put into a microwave oven, the present disclosure is not limited thereto. For example, opening/closing of a door of a microwave oven 1 or putting of an object on an IH cooker can be adopted as a start condition.

(2) A start condition for the voice acceptance processing may be determined to be satisfied or not based not on a state change of one apparatus to be controlled 2000 but on state changes of the plurality of apparatuses to be controlled 2000.

In the example of the fifth row in FIG. 3, a telephone set with an apparatus ID “telephone_01” and an IH cooker with an apparatus ID “IH_001” are stored in the apparatus ID column 200. Then, in the start condition column 201, “incoming=true” indicative of an incoming call of the telephone set and “ih_cooker_state=On” indicative of use of the IH cooker are stored, and in the control target apparatus column 202, “IH cooker” is stored. Therefore, in a case where the telephone set has an incoming call during use of the IH cooker, the state determination unit 1122 identifies the IH cooker as a control target apparatus. In this case, a response sentence “Telephone has incoming call. How would you like IH in use?” is stored in the response sentence column 203. Thus, the response generating unit 1130 causes the voice output unit 3020 of the control apparatus 3000 to output the response sentence.

In this manner, in a case where the telephone set has an incoming call during use of the IH cooker, a user is allowed to stop the IH cooker or reduce the heat of the IH cooker and then go away from the IH cooker to answer the telephone by making a speech such as “stop” or “low frame”.

Similarly, in the example of the sixth row in FIG. 3, an intercom with an apparatus ID “intercom_01” and an IH cooker with an apparatus ID “IH_01” are stored in the apparatus ID column 200, “ring_intercom=true” indicating that the intercom has accepted ringing from a visitor and “ih_cooker_state=On” indicating that the IH cooker is in use are stored in the start condition column 201, and “IH cooker” is stored in the control target apparatus column 202.

Therefore, in a case where the intercom receives an incoming call during use of the IH cooker, the state determination unit 1122 identifies the IH cooker as a control target apparatus. In this case, a response sentence “A visitor. How would you like the IH in use?” is stored in the response sentence column 203. Therefore, the response generating unit 1130 causes the voice output unit 3020 of the control apparatus 3000 to output this response sentence.

In this manner, in a case where the intercom receives ringing during use of the IH cooker, a user is allowed to stop the IH cooker or reduce the heat of the IH cooker and then go away from the IH cooker to answer the ringing of the intercom by making a speech such as “stop” or “low frame”.

Additionally, in the example of the seventh row in FIG. 3, the intercom with the apparatus ID “intercom_01” and a television set with an apparatus ID “TV_01” are stored in the apparatus ID column 200. Then, “ring_intercom=true” indicating that the intercom has accepted ringing from a visitor and “tv_state=On” indicating that the television set is ON are stored in the start condition column 201, and “television set/recorder” is stored in the control target apparatus column 202. Therefore, in a case where the intercom has ringing during viewing of the television, the state determination unit 1122 identifies the television set and the recorder as control target apparatuses. In this case, a response sentence “A visitor. How would you like the television you are watching?” is stored in the response sentence column 203. Therefore, the response generating unit 1130 causes the voice output unit 3020 of the control apparatus 3000 to output this response sentence.

In this manner, in a case where a visitor comes during viewing of the television, a user is allowed to turn off the television set as well as causing the recorder to record a television program being viewed by, for example, making a speech such as “TV, off. Recorder, record.”.

(3) While the above embodiments show an example where a response sentence urging control of a control target apparatus is output from the control apparatus 3000 at the start of the voice acceptance processing, the present disclosure is not limited thereto. A response sentence urging execution of service related to a control target apparatus can be output from the control apparatus 3000 at the start of the voice acceptance processing.

In the example of the third row in FIG. 3, an apparatus ID “refrigerator_01” is stored in the apparatus ID column 200, “door_state=Open” is stored in the start condition column 201, “refrigerator” is stored in the control target apparatus column 202, and a response sentence “Please let us know out of stock and the like” is stored in the response sentence column 203. This response sentence is one example of fifth information.

Therefore, when the door of the refrigerator enters the open state, the state determination unit 1122 identifies the refrigerator as a control target apparatus. Then, the response generating unit 1130 causes the voice output unit 3020 of the control apparatus 3000 to output the response sentence.

In this case, the user makes a speech to the effect that food materials out of stock in the refrigerator should be bought, such as “Buy some more tomatoes”. The voice processing device 1000 responsively, for example, accesses a food material purchase site on the cloud and conducts processing of buying some more food materials in place of the user. As a result, the additionally bought food materials will be delivered to a user's house, so that the user can restock the food materials out of stock in the refrigerator. In this case, with a voice dialog dictionary corresponding to service related to a control target apparatus stored in the voice dialog dictionary DB 1210, the control command decision unit 1121 need only refer to the voice dialog dictionary and decide service execution contents.

(4) While in the above embodiments, a response sentence urging a user to make a speech is output by voice from the control apparatus 3000 at the start of the voice acceptance processing, the present disclosure is not limited thereto. In a case, for example, where the control apparatus 3000 includes a light emitting device such as an LED, the control apparatus 3000 may cause the light emitting device to output light in place of or in addition to voice output of a response sentence. Additionally, the control apparatus 3000 may cause the voice output unit 3020 to output electronic sound such as beep sound in place of voice output of a response sentence. Additionally, in a case where the control apparatus 3000 includes a display, the control apparatus 3000 may cause the display to display video of a response sentence in place of or in addition to voice output of the response sentence. Also, these modes can be appropriately combined.

### INDUSTRIAL APPLICABILITY

The present disclosure, which can reduce user's load in controlling an apparatus by voice dialog, is useful in technical fields in which an apparatus is controlled by voice dialog and service related to an apparatus is executed.

1. A method conducted by a control device which controls an apparatus based on contents of user's speech, comprising:
detecting a state change of at least one of a plurality of apparatuses;
identifying a control target apparatus from among the plurality of apparatuses based on first information indicative of the state change; and
in a case where the control target apparatus is identified, starting voice acceptance processing of accepting voice of a user by using a sound collecting device, and outputting a notification for urging the user to make a speech related to the control target apparatus.

2. The method according to claim 1, wherein the notification is fourth information including second information corresponding to the control target apparatus and third information indicative of at least a part of control contents for the control target apparatus.

3. The method according to claim 1, wherein the state change is detected based on a sensor value obtained from a sensor provided in some of the plurality of apparatuses.

4. The method according to claim 1, wherein further, in a case where after the voice acceptance processing is started, a state where the control target apparatus is not controlled for a fixed period is detected, the voice acceptance processing is resumed and the notification is output.

5. The method according to claim 1, wherein the notification is fifth information which urges a speech for executing service related to the control target apparatus.

6. The method according to claim 1, wherein the notification is voice output from a voice output device.

7. The method according to claim 1, wherein the notification is sound output from an electronic sound output device.

8. The method according to claim 1, wherein the notification is video output from a display.

9. The method according to claim 1, wherein the notification is light output from a light emitting device.

10. The method according to claim 1, wherein
the sound collecting device is installed at a position different from a position of the control target apparatus, and
in the voice acceptance processing, the sound collecting device executes directivity control of directing directivity of a microphone to a direction predetermined relative to the control target apparatus.

11. The method according to claim 10, wherein the direction predetermined is decided based on a history of directions of sounds collected by the sound collecting device from voice of speech made by the user for controlling the control target apparatus.

12. The method according to claim 1, wherein in identifying the control target apparatus, in a case where a first apparatus among the plurality of apparatuses changes to a given state and a second apparatus different from the first apparatus changes to a given state, at least one of the first apparatus and the second apparatus is identified as the control target apparatus.

13. A control device which controls an apparatus based on contents of user's speech, comprising:
a detection unit which detects a state change of at least one of a plurality of apparatuses;
an identification unit which identifies a control target apparatus from among the plurality of apparatuses based on first information indicative of the state change; and
an output unit which, in a case where the control target apparatus is identified, starts voice acceptance processing and outputs a notification for urging a user to make a speech related to the control target apparatus.

14. A non-transitory computer-readable recording medium which stores a program which causes a computer to execute the method according to claim 1.
